(19) United States
(12) Patent Application Publication
(10) Pub. No.: US 2025/0041903 A1
(43) Pub. Date: Feb. 6, 2025

(54) CLEANING SHEET

(71) Applicant: Probe Innovation, Inc., Hiroshima-City (JP)

(72) Inventors: Akiko IWANA, Hiroshima-City (JP); Tadashi ROKKAKU, Irving, TX (US); Takanori FUJIWARA, Higashihiroshima-City (JP)

(73) Assignee: Probe Innovation, Inc., Hiroshima-City (JP)

(21) Appl. No.: 18/787,881

(22) Filed: Jul. 29, 2024

(30) Foreign Application Priority Data
Aug. 3, 2023 (JP) 2023-135913
May 20, 2024 (JP) 2024-081640

(51) Int. Cl. B08B 1/14

(52) U.S. Cl. CPC B08B 1/143

(57) ABSTRACT

An object is to provide a cleaning sheet of which aim is to clean dusts of a pad adhered to a top part of a probe pin provided to an electronic testing of a semiconductor and that makes cleaning having a function for lowering a contact resistance between the probe and the electrode pad. Bubbles or air-layers in a sponge sheet consisted of melanin resin or urethane rubber is replaced with gel or polishing gel mixed with polishing powders having sizes not more than several tens of micrometers.

### RELATED APPLICATIONS

This application is based upon and claims the benefit of and priority to Japanese Patent Application No. 2023-135913 filed Aug. 3, 2023, and Japanese Patent Application No. 2024-081640 filed May 20, 2024, with the Japanese Patent Office, both of which are incorporated herein by reference in their entireties.

### TECHNICAL FIELD

The present invention relates to a cleaning sheet for cleaning a top part of a probe for an electronic testing of a semiconductor.

### BACKGROUND ART

To atop of a probe for an electronic testing of a semiconductor, fragments of objective pads for testing adhere as powdery dusts and deposition of them gives noises to testing signals. Thus, the powdery dusts are necessary to be removed by using a cleaning sheet from the top of the probe periodically.

Conventionally, a cleaning sheet generally used is a sponge sheet of which material is melamine resin or urethane rubber and the like, and those generally used are one that is applied with polishing gel or one that is sprayed and bonded polishing powders on the surface of the sheet having bubble pores on its surface and including inside air layers and bubbles.

In addition, instead of the sponge sheet, there are also cases where the sheet, which is made of silicone rubber or liquid-silicone rubber etc. and has adequate hardness, elasticity, and fracture strength while being mixed with polishing powders, is used as the cleaning sheet.

Hereunder, two examples of the cleaning sheets conventionally used are described using FIG. 8, FIG. 9, and FIG. 10.

FIG. 8 is a drawing describing a structure and its work of the cleaning sheet that becomes generally and widely popular for the probe. In the same drawing, the cleaning sheet 51 is made of the melamine resin or the urethane rubber and has a configuration in which the polishing gel 54 made by mixing the fine polishing powders is applied onto the sponge sheet 52 having a plurality of bubbles or air-layers 53 and then is applied onto a substrate sheet 55.

The same drawing FIGS. 8a and b illustrate the states before and after inserting the probe 56 into the aforementioned cleaning sheet 51, respectively. In the same drawing FIG. 8b, the state is illustrated where the probe 56 is inserted into the aforementioned cleaning sheet 51 from a direction of an arrow 59 and thus the top part 57 of the probe wraps a part 58 of the aforementioned polishing gel 54 into the aforementioned sponge sheet 52.

In this instance, under the condition where the part 58 of the aforementioned polishing gel is sandwiched between the top part 57 of the probe and the aforementioned sponge sheet 52, the surface of the top part 57 of the probe is cleaned.

By alternatively moving the aforementioned probe 56 with changing its insertion position along the directions of arrows 59, 60 in the same drawing FIGS. 8a and b, the cleaning of the top part 57 of the probe is achieved.

However, in the cleaning of the probe by the above-mentioned cleaning sheet 51, there were following inconveniences.

A first inconvenience is that a thickness of the aforementioned polishing gel 54 is less, upon the aforementioned top part 57 of the probe reaching the sponge sheet after passing through the aforementioned polishing gel 54, such that the cleaning may not be possible and thus effects of the cleaning becomes less. As the result, dusts of the pads at the top of the probe not shown are easy to be left such that contact resistance becomes large.

A second inconvenience will be described according to FIG. 9. A bottom end 61 of the aforementioned top part 57 of the probe will wear unevenly such that its size becomes larger, and the bottom end loses a sharp shape as shown by a sign 62 in the same figure. When the shape of the bottom end 61 loses sharpness as shown by the sign 62, a facing pressure on a contact face between the testing pad not shown becomes lower such that a contact resistance becomes larger, because oxide films on the testing pad of the testing object not shown and on the surface of the bottom end 62 become harder to be broken.

The aforementioned first and second inconveniences are all caused due to less thickness of the aforementioned polishing gel 54. However, to thicken the thickness of the aforementioned polishing gel 54 generates flow-off of the polishing gel 54 which is viscose fluid and contamination of peripheral regions such that the thickening is practically difficult.

Next, according to FIG. 10, another inconvenience of the conventional instance will be described. In FIG. 8, the cleaning sheet 71 has a configuration in which a substrate sheet 74 is adhered to an elastic sheet 72 which is formed by mixing the polishing powders 73 with the silicone rubber or the liquid silicone.

In FIG. 10, when the top part 76 of the probe 75 is plunged into the aforementioned elastic sheet 72, due to the contact with the aforementioned polishing powders 73, the pad dusts adhered onto the aforementioned top part 76 can be removed. Thus, when the probe 75 is moved repeatedly along the directions of arrows 77, 78, the adhered dusts of the electrode pad not shown at the aforementioned top part 76 can be removed.

However, the aforementioned elastic sheet 72 is the silicone rubber or the liquid silicone, and thus, is highly viscose and adherent; when the aforementioned probe 75 is moved at high speed, there is another inconvenience in which a part of the elastic sheet 72 becomes adhered to the probe 75 such that a cleaning efficiency becomes lower.

### PRIOR ART LITERATURE

### Patent Literature

Patent Literature 1 JPH11-345846
Patent Literature 2 JP2008-039706

### SUMMARY OF INVENTION

### Problem to be Solved by Invention

An object is to provide a cleaning sheet of which major aim is to clean dusts of a pad adhered to a top part of a probe pin provided to the electronic testing of a semiconductor and that allows cleaning having a function for lowering a contact resistance between the probe and the electrode pad in a short time duration with high efficiency.

### Means for Solving Problem

According to claim 1 of the present invention, a cleaning sheet for cleaning a top part of a probe for an electronic testing of a semiconductor is characterized in that air in air-layers or in bubbles in a sponge sheet of a melanin resin or urethane rubber and the like used as materials is replaced with gel or polishing gel.

According to claim 2 of the present invention, the cleaning sheet of the aforementioned claim 1 is characterized in that when replacing air in air-layers or in bubbles in a sponge sheet of melanin resin and urethane rubber and the like as materials with gel or polishing gel, impregnating low viscose liquid such as low viscose liquid silicone, low viscose liquid epoxy resin and the like or low-viscose polishing liquid mixed with polishing powders and then heating and curing the low viscose liquid or the low-viscose polishing liquid to form low viscose gel or low-viscose polishing gel.

### Advantageous Effect of Invention

In a cleaning sheet to which the present invention is applied, the following advantages are obtained. A first advantage is, due to plunging deeply a probe to a sponge sheet having large thickness and being filled with polishing gel or gel, a contact frequency between a top part of the probe and the polishing gel or the gel and sponge fibers become higher to remove sufficiently adhered dusts of an electrode pad such that the contact resistance between the electrode pad and the probe can be kept low.

A second advantage is, due to lowering a contact area between a bottom region of the probe and the electrode pad while enlarging a Hertz stress at the contact face, to make easy to obtain a good contact conduction by breaking an oxide film at a contact face.

Because of plunging deeply the probe into the sponge sheet which has a large thickness and is filled inside with the polishing gel or the gel, an outer peripheral face of the top part of the probe as well as the bottom region of the top of the probe contacts with the sponge fibers keeping the polishing gel or the gel so that an advantage that conforms a shape of the probe and keeps the sharp shape of the top part can be achieved. When the top part of the probe can keep the sharp shape, the contact area between the bottom region becomes smaller such that the Hertz stress becomes large.

Now, even if the gel that does not include the polishing gel rather than the polishing powders in the bubbles or the air-layers is filled, and in the case where the sponge is a melamine sponge, the fibers of the sponge have the working that polishes a probe surface such that the cleaning working of the top part of the probe can be obtained when the gel rather than the polishing gel is used.

A third advantage is, due to plunging deeply the probe, the contact frequency between the top part of the probe and the polishing gel or the gel becomes higher and thus the adhered dusts to the electrode pad are removed sufficiently such that even when plunging times of the probe into the sponge sheet are made fewer, the contact resistance between the electrode pad and the probe can be kept low. This provides the advantage of shortening a time duration required for the cleaning while enhancing the cleaning efficiency. Particularly, shortening the cleaning time duration in an expensive prober enhances an availability of the prober while reducing cleaning costs.

### BRIEF DESCRIPTION OF DRAWINGS

FIG. 1 is a schematic drawing of a sponge sheet as an application object of the present invention in which air in air-layers and bubbles inside a sponge sheet is replaced with polishing gel.

FIG. 2 is a schematic drawing of a production method of the sponge sheet of which air in air-layers and bubbles in a sponge sheet is replaced with polishing gel.

FIG. 3a is a drawing of a sponge sheet before starting production.

FIG. 3b is a drawing of a sheet to which the polishing gel or the gel is scattered and fixed in the air-layer and bubbles in the sponge sheet by applying the present invention.

FIG. 4a is an explanatory drawing explaining actions and advantages of the sponge sheet for cleaning the top part of the probe.

FIG. 4b is an explanatory drawing explaining actions and advantages of the sponge sheet for cleaning the top part of the probe.

FIG. 5a is an explanatory drawing comparing and explaining differences in advantages as changes in contact resistances when a conventional probe cleaning sheet is applied.

FIG. 5b is an explanatory drawing comparing and explaining differences in advantages as changes in contact resistances when a sponge sheet according to the present invention is applied.

FIG. 6a is an explanatory drawing of a second example as an application example of claim 2.

FIG. 6b is an explanatory drawing of a second example as an application example of claim 2.

FIG. 7 is an explanatory drawing of a second example as an application example of claim 2.

FIG. 8a is an explanatory drawing of structures and actions of a conventional cleaning sheet for a probe.

FIG. 8b is an explanatory drawing of structures and actions of a conventional cleaning sheet for a probe.

FIG. 9 is an explanatory drawing of inconveniences of a conventional cleaning sheet for a probe.

FIG. 10a is an explanatory drawing of a conventional cleaning sheet with which polishing powders are mixed to an elastic body formed by silicone rubber or liquid silicone.

FIG. 10b is an explanatory drawing of a conventional cleaning sheet with which polishing powders are mixed to an elastic body formed by silicone rubber or liquid silicone.

### EMBODIMENT FOR PRACTICING INVENTION

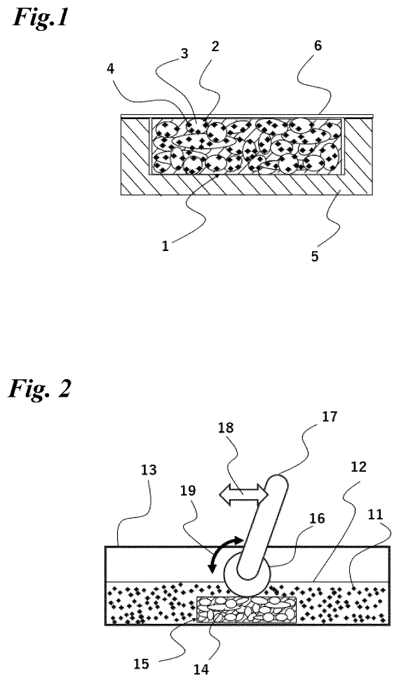

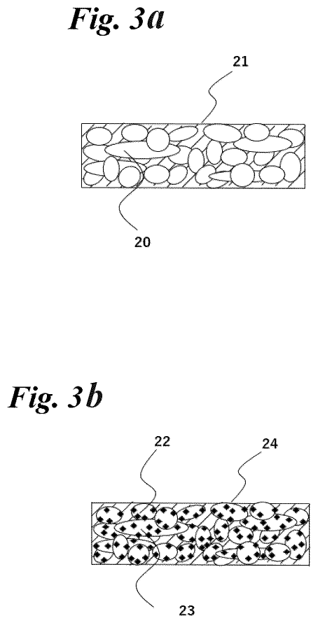

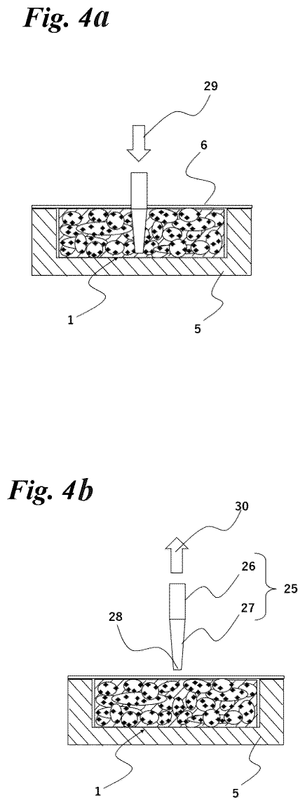

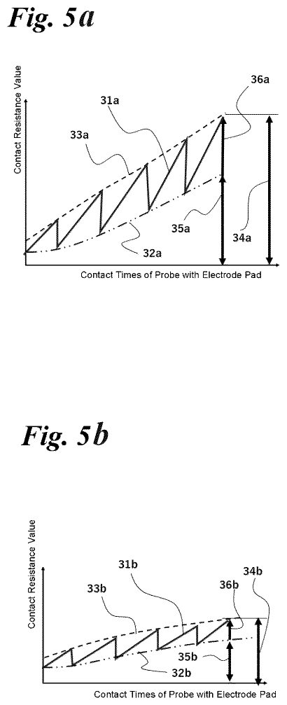

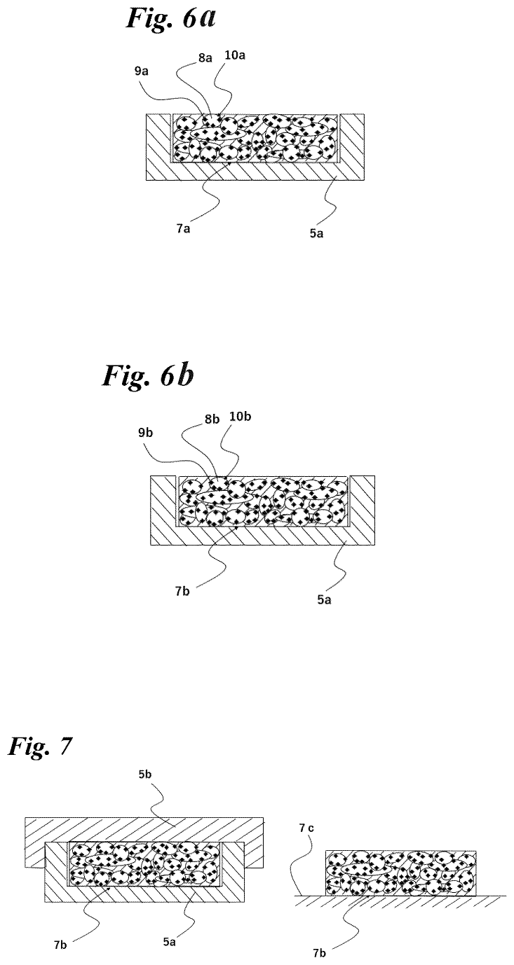

Hereunder, embodiments relating to the present invention will be described in detail with reference to drawings. A first example of the present invention will be described according to FIG. 1, FIG. 2, FIG. 3a, FIG. 3b, FIG. 4a, FIG. 4b, FIG. 5a, FIG. 5b, FIG. 6a and FIG. 6b.

### First Example

As to an application object example of the present invention and as to a first example, FIG. 1 shows a sponge sheet in which air in air-layers and in bubbles in the sponge sheet are replaced with polishing gel mixed with fine polishing powders.

In FIG. 1, a sign 1 illustrates the sponge sheet in which the air in the air-layers and the bubbles inside the sponge sheet are replaced with the polishing gel, and a sign 2 illustrates a plurality of the polishing gel bubbles. A plurality of the aforementioned polishing gel bubbles 2 is composed from the gel 3 and a plurality of polishing powders 4 while continuing other polishing gel bubbles.

The aforementioned sponge sheet 1, which includes inside the polishing gel bubbles, is surrounded by a case 5 at five faces except for an upper face so as not to make the polishing gel flow outside. The upper face of the sponge sheet 1 including inside the aforementioned polishing gel bubbles is covered by a thin plastic film 6, and the plastic film 6 is adhered to the case 5 at its peripheral part.

Next, according to FIG. 2, a production method of the sponge sheet 1 illustrated in FIG. 1 will be explained.

In FIG. 2, the polishing gel 12a, to which a plurality of fine polishing powders 11a is mixed, files a container 13a by almost half of its height. At a bottom of the aforementioned container 13a, a sponge sheet 15a, which includes inside a plurality of the air-layers and the bubbles 14a, is immersed and is prevented from its floating up by a rotation roller 16a.

The aforementioned rotation roller 16a is supported rotatably near a lower end of a lever 17a and when the lever 17a is moved reciprocally along a direction of an arrow 18a while being pushed toward the bottom of the container 13a, the rotation roller 16a squeezes the air in the air-layers inside the sponge sheet 15a or the air inside the bubbles 14a.

By the squeezing action of the aforementioned rotation roller 16a and after the air in the air-layers inside the sponge sheet 15a or inside the bubbles 14a is sufficiently squeezed, leaving the sponge sheet 15a as is at the bottom of the container 13a for a while makes the sponge sheet 15a absorb inside the polishing gel 12a in the container 13a due to an elastic-returning action the sponge sheet 15a. Thus, the air-layers or the bubbles 14a in the sponge sheet 15a can be replaced with the aforementioned polishing gel 12a.

The sponge sheet 15a of which the air-layers or the bubbles is replaced with the polishing gel 12a are transferred to the case 5 shown in FIG. 1 and by covering the upper face thereof by the plastic film 6 provides the sponge sheet 1 including the polishing gel bubbles inside shown in FIG. 1.

Thus, the sponge sheet 21 as shown in FIG. 3a, which includes a plurality of the air-layers or the bubbles 20 inside, can be converted to a polishing gel bubbles 23a as shown in FIG. 3b in which the insides of the aforementioned bubbles 20 are replaced with the polishing gel.

Next, using FIG. 4 and FIG. 5 actions and advantages of the sponge sheet for cleaning the top part of the probe will be described.

FIG. 4 shows a configuration shown in FIG. 1 in which the sponge sheet 1 including the polishing gel bubbles inside is retained in the case 5 and then is covered by the thin plastic film 6 for preventing evaporation of moisture. By FIG. 4, the actions and the advantages will be explained in the case where the sponge sheet 1 is applied to the cleaning of the probe 25.

The aforementioned probe 25 is configured by a straight part 26, a conical-shaped part 27 and a bottom end part 28. The probe 25 is applied with operations of plunging and pulling into and from the aforementioned sponge sheet 1 alternatively for plural times along directions of an arrow 29 and an arrow 30 shown in FIG. 4a and FIG. 4b. In this case, the aforementioned conical-shaped part 27 is formed to be plunged with its entire length into the aforementioned sponge sheet 1.

Generally, the dusts adhered when contacting with the electrode pad are collectively fixed around the bottom end part 28 of the probe. In the conventional cleaning sheet, since the polishing payer is thin, there was an inconvenience that the adhered dusts cannot be removed sufficiently.

However, as shown in FIGS. 4a and b, by performing the cleaning repeatedly where the aforementioned conical-shaped part 27 of the probe is plunged into the sponge sheet 1 including the polishing gel bubbles inside over its entire length, the following advantages are provided.

A first advantage is, because the times that the top part 28 of the probe contacts to the fine polishing powders inside the aforementioned sponge sheet and the dusts depositing and adhering about the top part 28 of the probe can be surely removed, to reduce the contact resistance caused by the adhered dusts to the aforementioned electrode pad.

A second advantage is, because the cleaning is performed repeatedly where the aforementioned conical-shaped part 27 along the entire length is plunged into the sponge sheet 1 including the aforementioned polishing gel inside; to keep the aforementioned conical-shape; to keep the shape of the aforementioned top part sharp; to make the area of the contact face with the pad electrode less and to keep the contact resistance lower by breaking the oxide film on the pad surface.

As a third advantage brought by the above first and the second advantages, the contact resistance between the probe and the electrode pad is kept less so that a lifetime of the probe can become longer.

FIG. 5 schematically illustrates the above first, second and third advantages. FIG. 5a is a drawing that illustrates schematically changes of the contact resistance of the probe when a conventional cleaning sheet is used.

In the chart shown in FIG. 5a, an abscissa represents the contact times of the probe to the electrode pad and an ordinate represents the contact resistance value. The saw-shaped line 31a is the line that indicates large changes in the contact resistance before and after the cleaning. The line shown by the two-dot chain line 32a is the line that connects the minimum values of largely decreased values of the contact resistance values just after the cleaning. The line shown by the dot line 33a is the line that connects the maximum values of the contact resistance values reached before the cleaning. When the contact resistance value reaches the uppermost allowed value 34a of the contact resistance value, it is regarded that the probe becomes its lifetime.

The arrow 35a represents the contact resistance value caused by the oxide film on the probe surface when the probe becomes its lifetime. In addition, the arrow 36a represents the contact resistance value caused by the adhered dusts of the electrode pad deposited on the top part of the probe when the probe becomes its lifetime.

In the probe that has been cleaned using the conventional cleaning sheet shown in FIG. 5a, both of the contact resistance value caused by the oxide film on the probe surface and the contact resistance value caused by the adhered dusts of the electrode pad deposited on the top part of the probe is large and this reason is as follows:

When the conventional cleaning sheet is used, since the polishing layer is thin and thus, the contact times and the time duration of the top part of the probe with the polishing powders for removing the adhered dusts, the adhered dusts cannot be removed sufficiently such that the contact resistance value due to the adhered dusts of the electrode pad deposited on the top part of the probe becomes large.

Furthermore, the usage of the conventional cleaning sheet, because the polishing layer on the cleaning sheet is thin, the top part of the probe intensively suffers to the uneven wear such that the sharpness of the top part of the probe becomes lost and the shape becomes dull. As the result, the contact Hertz stress for obtaining good electrical conduction by the destruction of the oxide film that relates to the contact resistance with the electrode pad becomes smaller such that the oxide film cannot be destructed. As the result, the contact resistance with the electrode pad becomes larger and the resistance value shown by the arrow 35a becomes higher.

Contradictory to the above, when the sponge sheet to which the present invention is applied to the cleaning of the top part of the probe, both of the contact resistance value caused by the adhered dusts of the electrode pad deposited on the aforementioned top part of the probe and the contact resistance value caused by the oxide film on the probe surface becomes lower. This reason will be described according to FIG. 4 and FIG. 5b.

As the sponge sheet for cleaning, the sponge sheet 24 as shown in FIG. 3b to which the polishing gel 23 is filled inside the air-layers and inside the bubble 20 is used.

When the cleaning movements are applied, which contains plunging the probe 25 shown in FIG. 4 into the aforementioned sponge sheet 1 along the direction shown by the arrow 29 so as to plunge the entire length of the conical-shape part 27 and then pulling it to the direction of the arrow 30 repeatedly, when comparing the case using the conventional cleaning sheet, both of the contact resistance value caused by the adhered dusts of the electrode pad deposited on the aforementioned top part of the probe and the contact resistance value caused by the oxide films on the probe surface and the electrode surface not shown becomes lower. This reason will be described as follows:

In FIG. 4, the aforementioned probe 25 is plunged deeply into the sponge sheet 1 shown in the aforementioned FIG. 1 such that the adhered dusts of the electrode pad not shown and deposited collectively near the bottom end of the probe 25 have the long contact distance with the polishing powders 4 scattered in the polishing gel bubble 2 of the sponge sheet 1 of the aforementioned FIG. 1 while having high contact frequencies. As the result, the adhered dusts of the aforementioned electrode pad can be removed sufficiently such that the contact resistance value caused by the adhered dusts of the electrode pad becomes lower.

Furthermore, the probe 25 is plunged deeply into the aforementioned sponge sheet 1 such that the conical-shape 27 of the probe contacts with the aforementioned polishing powders 4 as well as the top part and the bottom end part 28 along the entire region of the length direction of the conical-shape part and receives the polishing action for regenerating the shape along the entire region of the length direction of the conical-shape part 27. As the result, the sharp shape of the aforementioned conical shape part 27 can be kept such that the stress at the contact face between the electrode pad not shown and the bottom end part 28 of the probe becomes higher and the contact resistance value caused by the oxide films of the surface of the bottom end part 28 of the probe and the surface of the electrode pad not shown becomes lower. The advantage obtained as the result that the contact resistance as the probe becomes lower will be described according to FIG. 5b.

In the chart shown in FIG. 5b, an abscissa represents the contact times of the electrode pad with the probe, and an ordinate represents the contact resistance values. The saw-shaped line 31b is the line which indicates large changes of the contact resistances before and after the cleaning. The line 32b illustrated by the two-dot chain line is the line connecting the minimum values of the values of the contact resistance values which decrease significantly just after the cleaning. The line 33b illustrated by the dot line is the line connecting the maximum values of the contact resistance values which reached maximum before the cleaning. The contact resistance value 34b shows the contact resistance value just before the 6th cleaning.

When the contact resistance value 34b just before the aforementioned 6th cleaning is compared to 34a which is the result using the conventional cleaning sheet of FIG. 5a, the large difference is observed. This reason is that the usage of the sponge sheet 7 to which the present invention is applied makes both of the contact resistance value caused by the adhered dusts of the electrode pad deposited on the top part of the probe and the contact resistance value caused by the oxide films on the probe surface and the surface of the electrode pad not shown becomes lower.

### Second Example

In the first example, because the gel 3 shown in FIG. 1 uses the gel made of material having large flowability, in order to prevent flow-off to the outside, the upper face of the aforementioned cleaning sheet 1 is covered by the aforementioned plastic film 5 and the five faces other than the upper face had to be covered by the aforementioned case 5a.

This is not only making the cleaning of the cleaning sheet inconvenience but also making the planarity of the upper face of the cleaning sheet degrade; for example, precise sharpening of a fine MEMS probe becomes difficult using the cleaning sheet.

In the second example explained in FIG. 6 and FIG. 7, the example corresponding to claim 2 of the present invention will be illustrated. In FIG. 6a, the sign 7a illustrate a sponge sheet including low-viscose polishing liquid inside; the sign 8a illustrate low viscose liquid; the sign 9a illustrate polishing powders mixed into the aforementioned low viscose liquid 8a, and the sign 10a illustrates bubbles or layers of the low-viscose polishing liquid.

As the aforementioned low viscose liquid 8a, for example, low viscose liquid silicone is used and when the aforementioned polishing powders 9a are immersed into the aforementioned sponge sheet 7a, due to the low viscose liquid, it is easy to form the bubbles or layers 10a of the aforementioned low-viscose polishing liquid. However, due to the low viscosity, it is easy to ooze and to escape out of the sponge sheet 7a such that it have to kept in the case 5a. It is difficult as is to serve the practical usage as the cleaning sheet.

FIG. 6b is a drawing explaining a process for changing the sponge sheet 7a including the low-viscose polishing liquid inside, which has been explained in FIG. 6a, to the sponge sheet 7b including the low-viscose polishing gel inside, which can be served to practical usage. The low viscosity liquid silicone 8a in the sponge sheet 7a including the aforementioned low-viscose polishing liquid is heated to form a gelatinous low viscose silicone rubber, i.e. a low-viscose polishing gel 8b. The sign 9b illustrate the polishing powders in the low-viscose polishing gel and the sign 10b illustrates the bubbles or layers of the low-viscose polishing gel as the gelatinized low viscose silicone rubber. In the aforementioned sponge sheet 7b including the low-viscose polishing gel inside, handling in transportation becomes enhanced and the usability as the cleaning sheet at a client side becomes improved. In FIG. 7, this will be explained.

In FIG. 7, the sign 5b is a cover for the transportation. Since the aforementioned sponge sheet 7a is the sponge sheet 7b including the low-viscose polishing gel as the gel of the low-viscose silicone rubber such that the gel cannot escape outside and can be carried sufficiently by a simple carrier cover. In addition, the low-viscose silicone rubber is sticky such that when using at the client side as the cleaning sheet, the sponge sheet 7b is taken out from the case 5a. Even when being placed on the table shown 7c in FIG. 7, only placing does not allow to move such that fixing by an adhesive tape and so on becomes unnecessary.

In the second example illustrated in FIG. 6 and FIG. 7, the following advantages will be expected.

(1) First, since the sponge sheet is one that include the low-viscose polishing gel inside as the gel of the low-viscosity silicone rubber, the precision of the planarity of the upper face of the sheet can be improved. This allows an application to sharpening of the fine MEMS probe (forming sharp shape at the top) as well as an application of the cleaning sheet for the top part of the probe. Because the gel of the cleaning sheet of the present invention is the polishing gel including the polishing powders, only plunging the top of the fine MEMS probe repeatedly into the aforementioned sponge sheet including the low-viscose polishing gel as the gel of the low-viscose silicone rubber makes the top of the MEMS probe made of a relatively soft material as the sharp shape.

(2) Second, it becomes possible to regenerate the shape of the aforementioned wone MEMS probe.

### DESCRIPTION OF SIGNS

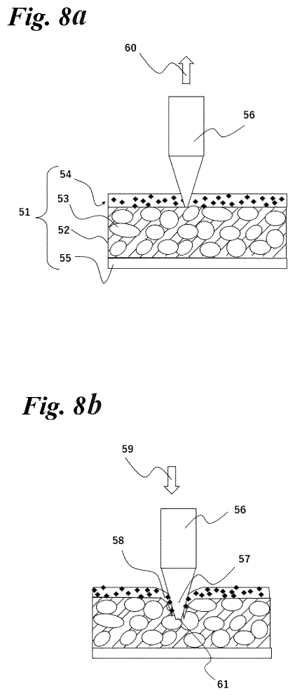

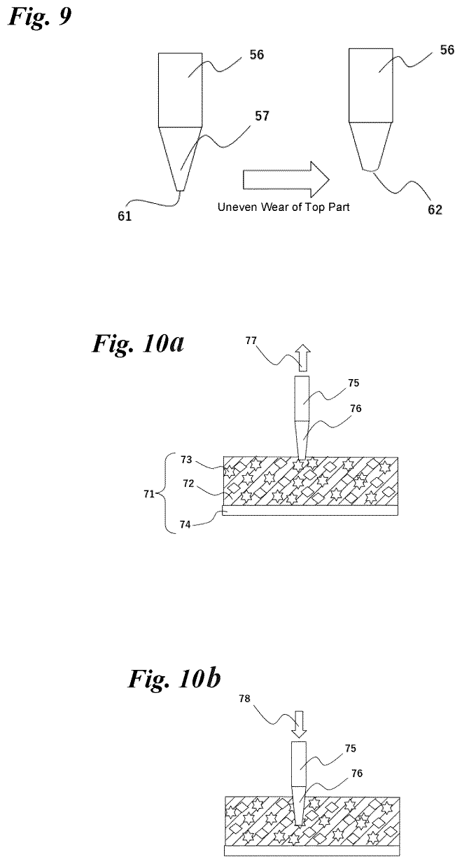

1 cleaning sheet including polishing gel inside
2 bubbles of polishing gel
3 gel
4 polishing powders
5 case
5a case
5b carrier cover
6 plastic film
7a sponge sheet including inside bubbly low-viscose polishing liquid
8a low viscose liquid
9a polishing powders in low-viscose polishing liquid
10a bubbles or layers of low-viscose polishing gel
7b sponge sheet including inside low-viscose polishing liquid
7c table
8b low viscose gel
9b polishing powders in low-viscose polishing gel
10b bubbles or layers of low-viscose polishing gel
11 polishing powder
12 polishing gel
13 container
14 bubble
15 sponge sheet
16 rotation roller
17 grip
18 arrow
19 arrow
20 a plurality of air-layers or bubbles
21 sponge sheet
22 polishing powder
23 bubbles of polishing gel
24 sponge sheet
25 probe
26 straight part
27 conical shape part
28 bottom end part
29 arrow
30 arrow
31a, 31b saw-shaped line
32a, 32b line that connects the minimum values of largely decreased values of the contact resistance values after the cleaning
33a, 33b line that connects the maximum values of the contact resistance values reached before the cleaning
34a allowed upper limit of contact resistance value
34b contact resistance value just before 6th cleaning
35a, 35b contact resistance value caused by oxide film on probe surface
36a contact resistance value caused by adhered and deposited dusts of electrode pad
36b contact resistance value caused by adhered and deposited dusts of electrode pad Following is signs and naming for describing a conventional example using FIG. 8, FIG. 9 and FIG. 10
53 straight standing pin
54 conical shape part at top
54w worn conical shape part of top of conical shaped part
54r regenerated top part of conical shape
55 table
56 container
57 chemical etching solution
58 arrow
59 arrow
60 polishing cleaning gel
61 polishing powders
62 fluid becoming gelatinous
63 support membrane
64 adhering layer
65 film of polishing cleaning gel
66 arrow

What is claimed is:

1. A cleaning sheet for cleaning a top part of a probe for an electronic testing of a semiconductor, wherein air in air-layers or in bubbles in a sponge sheet of melamine resin or urethane rubber and the like used as materials is replaced with gel or polishing gel.

2. The cleaning sheet of claim 1, when replacing air in air-layers or in bubbles in a sponge sheet of melanin resin and urethane rubber and the like as materials with gel or polishing gel, impregnating low-viscose liquid such as low-viscose liquid silicone, low-viscose liquid epoxy resin and the like or low-viscose polishing liquid mixed with polishing powders, and then heating and curing the low-viscose liquid or the low-viscose polishing liquid to form low-viscose gel or low-viscose polishing gel.
